(19) United States
(12) Patent Application Publication
(10) Pub. No.: US 2025/0294036 A1
(43) Pub. Date: Sep. 18, 2025

(54) Methods and Systems for Forecasting Subsequent Computer System Log Events Based on Analysis of Historical Log Data

(71) Applicant: PRE Security Inc., Salt Lake City, UT (US)

(72) Inventors: John Uliss Peterson, Morgan Hill, CA (US); Paul Soren Jespersen, Provo, UT (US)

(21) Appl. No.: 19/075,530

(22) Filed: Mar. 10, 2025

Related U.S. Application Data
(60) Provisional application No. 63/566,103, filed on Mar. 15, 2024.

(51) Int. Cl. H04L 9/40

(52) U.S. Cl. CPC H04L 63/1416; H04L 63/1425

(57) ABSTRACT

Embodiments of the disclosure relate to methods and systems within the domains of computer science and artificial intelligence for analyzing and forecasting computer system log events. In some embodiments the present technology addresses the challenge of consolidating a variety of log data from multiple tool vendors into a unified and interpretable format. By utilizing an innovative approach to identify and categorize similarities within historical log data, the present technology streamlines the process of log analysis. These categorized log entries, or “common log signatures,” allow for enhanced monitoring and predictive insights into potential future events in a computer system. Embodiments include grouping of similar logs into discrete bucket categories, which enables the prediction of subsequent log events with greater accuracy and efficiency. This system offers significant advancements in the field of cybersecurity and predictive analytics, providing a robust framework for proactive system management and security protocol enhancement.

### CROSS-REFERENCE TO RELATED APPLICATION

This patent application claims the priority benefit of U.S. Provisional Patent Application No. 63/566,103 filed on Mar. 15, 2024, entitled “Method and Apparatus for Forecasting Subsequent Computer System Log Events Based on Analysis of Historical Log Data”. The aforementioned disclosure is hereby incorporated by reference herein in its entirety including all references cited therein for all purposes.

### FIELD OF THE TECHNOLOGY

The present disclosure relates to cybersecurity, specifically to methods and systems for analyzing computer system alert log events and forecasting cybersecurity threats to enhance cybersecurity mechanisms.

### BACKGROUND

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

In the rapidly evolving landscape of cybersecurity, the ability to detect and respond to cyber threats in real-time is of great importance. Traditional systems have primarily focused on identifying breaches after they occur, which often results in significant delays in response and mitigation. The speed at which cyber-attacks can compromise systems and extract sensitive information has outpaced the capabilities of many existing detection mechanisms. This challenge is compounded by the diverse and proprietary nature of data outputs from various security tools, such as firewalls and antivirus software, which lack standardization. This heterogeneity requires manual correlation of data, a process that is both time-consuming and prone to human error.

As cyber threats continue to grow in complexity and frequency, the limitations of current systems become increasingly apparent. The reliance on manual processes and the absence of predictive capabilities hinder the ability to preemptively address potential threats. There is a pressing need for innovative solutions that can rapidly process and analyze disparate data forms, predict cyber threats proactively, and respond with speed and precision. Such advancements would represent a significant leap forward in cybersecurity, enabling organizations to anticipate and mitigate attacks before they occur.

Log and data analysis are critical components of cybersecurity. Traditionally, systems designed to detect cyber-attacks have only been capable of identifying breaches after they have occurred. The industry's effort to reduce the mean time to detection has been an ongoing battle, with a significant focus on achieving real-time detection capabilities. However, real-time detection has proven to be insufficient, as the velocity of cyber-attacks allows attackers to compromise systems and extract critical information within milliseconds.

Complicating the detection and response to cyber threats is the diversity of data sources. Security tools such as firewalls, anti-virus software, and network traffic capture tools each output data in their unique, proprietary formats. The lack of standardization across these outputs creates a significant challenge for any single tool to correlate the information effectively. This heterogeneity of data has traditionally required security practitioners to manage various toolsets and rely heavily on manual correlation of attack information, a process that is both time-consuming and prone to human error.

The reliance on manual processes and the lack of real-time predictive capability in existing systems underscore the need for an innovative approach. As cybersecurity threats evolve in complexity and speed, the limitations of existing systems become more pronounced.

There is a recognized need for a system that can not only process and analyze disparate data forms rapidly but also predict and respond to cyber threats proactively. Such a system represents a substantial leap forward in the field of cybersecurity, offering the potential to anticipate attacks before they occur and to respond with unprecedented speed and precision.

### SUMMARY

Some embodiments relate to a computer implemented method of intelligently predicting cybersecurity events for preemptive cybersecurity defense mechanisms, including: receiving cybersecurity alert log data from a plurality of sources, the cybersecurity alert log data being from a plurality of time-sequenced events; transforming the cybersecurity alert log data from the plurality of sources using natural language processing into multi-dimensional alert signatures, the multi-dimensional alert signatures standardizing the cybersecurity alert log data from the plurality of sources; sorting the multi-dimensional alert signatures into a plurality of cosine similarity buckets; vectorizing the plurality of cosine similarity buckets into vectorized buckets of numerical values; storing the vectorized buckets in a vector database with corresponding metadata; training datasets using the vectorized buckets of the numerical values, the training datasets generating a predicting cybersecurity events model; validating the predicting cybersecurity events model using testing datasets; dynamically updating the predicting cybersecurity events model based on the validating; and predicting cybersecurity events for preemptive cyber defense mechanisms using the predicting cybersecurity events model.

In some embodiments the transforming the cybersecurity alert log data from the plurality of sources applies a predefined template for generating the multi-dimensional alert signatures.

In some embodiments the predicting cybersecurity events for preemptive cyber defense executes a cosine similarity analysis on the vectorized buckets of numerical values with the corresponding metadata.

In some embodiments the cosine similarity analysis generates a plurality of cybersecurity alert log categories.

Some embodiments further include categorizing the plurality of cybersecurity alert log categories, using a machine learning engine, into predefined cybersecurity threat categories.

In some embodiments the metadata includes: cybersecurity alert log data metadata, the cybersecurity alert log data metadata being from the cybersecurity alert log data from the plurality of sources, and multi-dimensional alert signatures metadata, the multi-dimensional alert signatures metadata being from the multi-dimensional alert signatures.

In some embodiments the cybersecurity alert log data metadata includes event timestamps of the time-sequenced events.

Some embodiments further include temporal sequencing the plurality of cybersecurity alert log categories using the event timestamps of the time-sequenced events, the temporal sequencing the plurality of cybersecurity alert log categories generating a historical pattern of cyber cybersecurity incidents for the predicting cybersecurity events model.

Some embodiments further include arranging the vectorized buckets of numerical values into a temporal sequence based on timestamp metadata to establish a chronological pattern of cybersecurity events.

In some embodiments the predicting cybersecurity events model includes a Long Short-Term Memory (LSTM) neural network configured to analyze time-sequenced data for predicting future cybersecurity events.

In some embodiments the predicting cybersecurity events for preemptive cyber defense mechanisms using the predicting cybersecurity events model generates a probability score for each predicted cybersecurity event.

Some embodiments further include ranking predicted cybersecurity events using the probability score for each predicted cybersecurity event, the ranking prioritizing the predicted cybersecurity events based on a likelihood of occurrence of each of the predicted cybersecurity events.

In some embodiments the predicting cybersecurity events for preemptive cyber defense mechanisms using the predicting cybersecurity events model includes generating a cybersecurity report for an entity, the cybersecurity report for the entity being based on the ranking the predicted cybersecurity events.

In some embodiments the validating the predicting cybersecurity events model using testing datasets executes the predicting cybersecurity events model using a code execution sandbox, the code execution sandbox testing the predicting cybersecurity events model.

Some embodiments further include automatically responding to a predicted cybersecurity event using a security orchestration, automation and response platform, the predicted cybersecurity event being based on the predicting cybersecurity events for preemptive cyber defense mechanisms using the predicting cybersecurity events model

Some embodiments include a system for intelligently predicting cybersecurity events for preemptive cybersecurity defense mechanisms, including: at least one processor; and a memory storing processor-executable instructions, wherein the at least one processor is configured to implement the following operations upon executing the processor-executable instructions: receiving cybersecurity alert log data from a plurality of sources, the cybersecurity alert log data being from a plurality of time-sequenced events; transforming the cybersecurity alert log data from the plurality of sources using natural language processing into multi-dimensional alert signatures, the multi-dimensional alert signatures standardizing the cybersecurity alert log data from the plurality of sources; sorting the multi-dimensional alert signatures into a plurality of cosine similarity buckets; vectorizing the plurality of cosine similarity buckets into vectorized buckets of numerical values; storing the vectorized buckets in a vector database with corresponding metadata; training datasets using the vectorized buckets of the numerical values, the training datasets generating a predicting cybersecurity events model; validating the predicting cybersecurity events model using testing datasets; dynamically updating the predicting cybersecurity events model based on the validating; and predicting cybersecurity events for preemptive cyber defense mechanisms using the predicting cybersecurity events model.

Some embodiments include a non-transitory computer-readable storage medium having embodied thereon instructions, which when executed by at least one processor, perform operations of a method including: receiving cybersecurity alert log data from a plurality of sources, the cybersecurity alert log data being from a plurality of time-sequenced events; transforming the cybersecurity alert log data from the plurality of sources using natural language processing into multi-dimensional alert signatures, the multi-dimensional alert signatures standardizing the cybersecurity alert log data from the plurality of sources; sorting the multi-dimensional alert signatures into a plurality of cosine similarity buckets; vectorizing the plurality of cosine similarity buckets into vectorized buckets of numerical values; storing the vectorized buckets in a vector database with corresponding metadata; training datasets using the vectorized buckets of the numerical values, the training datasets generating a predicting cybersecurity events model; validating the predicting cybersecurity events model using testing datasets; dynamically updating the predicting cybersecurity events model based on the validating; and predicting cybersecurity events for preemptive cyber defense mechanisms using the predicting cybersecurity events model.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 shows a block diagram of an exemplary system of intelligently predicting cybersecurity events for preemptive cybersecurity defense mechanisms, according to various embodiments of the present technology.

FIG. 2 shows a diagram of an exemplary knowledge based graph of an exemplary machine learning predicting cybersecurity events model for intelligently predicting cybersecurity events for preemptive cybersecurity defense mechanisms, according to exemplary embodiments of the present technology.

FIG. 3 shows a block diagram of an exemplary system architecture used for a intelligently predicting cybersecurity events for preemptive cybersecurity defense mechanisms, according to various embodiments of the present technology.

FIG. 4 is a block diagram of a process flow for intelligently predicting cybersecurity events for preemptive cybersecurity defense mechanisms, according to various embodiments of the present technology.

FIG. 5 illustrates an exemplary computer system that may be used to implement various embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood, that the disclosed embodiments are merely exemplary of the invention, which may be embodied in multiple forms. Those details disclosed herein are not to be interpreted in any form as limiting, but as the basis for the claims.

Embodiments of the disclosure relate to methods and systems within the domains of computer science and artificial intelligence for analyzing and forecasting computer system log events. In some embodiments the present technology addresses the challenge of consolidating a variety of log data from multiple tool vendors into a unified and interpretable format. By utilizing an innovative approach to identify and categorize similarities within historical log data, the present technology streamlines the process of log analysis. These categorized log entries, or “common log signatures,” allow for enhanced monitoring and predictive insights into potential future events in a computer system. Embodiments of the present technology involve grouping of similar logs into discrete bucket categories, which enables the prediction of subsequent log events with greater accuracy and efficiency. The present technology offers significant advancements in the field of cybersecurity and predictive analytics, providing a robust framework for proactive system management and security protocol enhancement.

According to some embodiments, the present technology is directed to methods and systems for optimizing the analysis of computer system logs through the application of natural language processing (NLP) and artificial intelligence (AI). By translating and transforming the complex data contained within system logs into a format akin to human language, the present technology significantly simplifies the interpretation of log events. This transformative process not only renders the data more accessible but also enables the efficient categorization of security events.

According to some embodiments, through vectorization and cosine similarity calculations, the present technology systematically assigns diverse security events into defined alert categories despite their disparate origins and descriptions across various tools. For instance, multiple different tool outputs indicative of a “brute force login” attack can be aggregated and understood as a singular category of threat. This categorization facilitates a more structured and uniform dataset for subsequent machine learning analysis, thereby enhancing the prediction and detection capabilities of cybersecurity systems.

According to some embodiments, the present technology introduces a method to enhance cybersecurity measures by predicting cyber-attacks before their actual occurrence. In some embodiments, the process begins with the aggregation of a comprehensive dataset from various cybersecurity tool vendors. This dataset comprises diverse alert logs, which are then processed through a conversion mechanism. The conversion mechanism utilizes an Artificial Intelligence (AI) tool such as a sophisticated large language model (LLM) for interpreting the alert data, which subsequently applies a predefined template to convert and standardize the data into a natural language format. The standardized data may then be deposited into a data lake for storage and further manipulation.

According to various embodiments, in the subsequent phase, the system meticulously strips the logs of all variable content, including but not limited to numerical data, dates, times, ports, protocols, event identifications, and Internet Protocol (IP) addresses. This purification process transforms the logs into a distilled alert log signature, maintaining the integrity of the natural language format. The purified alert log signatures may be vectorized to encapsulate the essence of the alert in a mathematical array, facilitating similarity comparisons and categorization.

According to some embodiments, the vectorized signatures, along with their corresponding metadata—which includes essential details such as event timestamps, and references to both the original log and its complete natural language representation—are then archived in a vector database. This comprehensive repository provides a structured framework for machine learning algorithms to access a uniform dataset, which significantly enhances the predictive accuracy and response capabilities of the system in identifying potential cyber threats.

According to various embodiments, building on the foundational processes described herein, the present technology progresses to the predictive stage utilizing the vector database. This vector database, now populated with “alert signatures” in vector form, underpins the prediction mechanism. When initiated, this prediction mechanism queries the vectorization index, executing a cosine similarity analysis on the dataset. This cosine similarity analysis discerns logs with similar profiles, grouping them into corresponding “alert log categories.” For instance, disparate logs depicting “brute force login” events, irrespective of their original disparate descriptions, are aggregated into a singular “brute force login” category. This classification simplifies the heretofore complex array of thousands of security logs into a manageable number of event buckets.

According to some embodiments a temporal sequencing operation arranges these buckets. The present technology uses the timestamp metadata to sequence the event buckets chronologically, based on the occurrence of the earliest alert within each bucket. This sequential mapping crafts a timeline of events, establishing a historical pattern of cyber security incidents. Such temporal sequencing is pivotal in some embodiments, providing a structured timeline, for example: ‘Bucket 1 occurred first, followed by Bucket 2, then Bucket 3’, and so forth. This exemplary sequence not only aids in understanding the progression of events but also may serve as a critical dataset for training machine learning algorithms to predict future security events, enhancing preemptive capabilities of the present technology.

According to various embodiments, continuing from the transformation and storage of log data into a vector database, the present technology advances to categorization and vectorization of log buckets. Specific categories, such as “malware downloads” and “brute force login attempt,” are assigned to these buckets. This categorization may be critical in various embodiments as this categorization represents the consolidated knowledge distilled from the diverse and previously uncorrelated log data.

According to some embodiments, with categories established, the system of the present technology vectorizes these categorical identifiers. This vectorization translates the categories into a mathematical format that can be readily processed for predictive analysis. Utilizing the time-stamped metadata from the log signatures, the system arranges the vectorized categories into a temporal sequence. This ordered sequence not only provides a historical account but also serves as a foundation for predictive analytics.

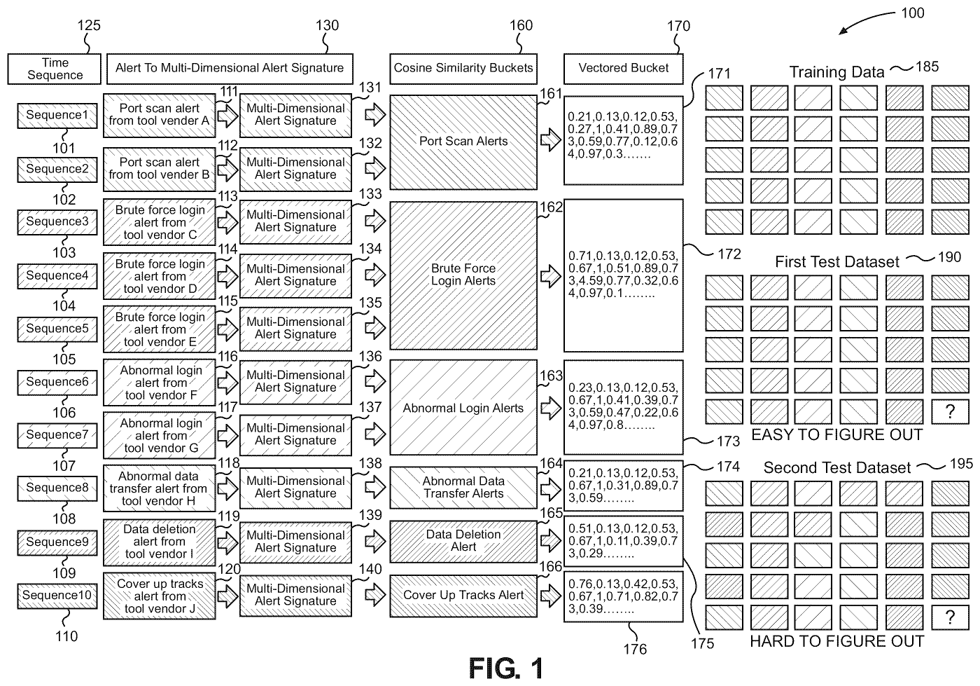

According to various embodiments, the predictive analytics phase leverages machine learning algorithms to forecast the likelihood and timing of future events. FIG. 1 shows a block diagram 100 of an exemplary system of intelligently predicting cybersecurity events for preemptive cybersecurity defense mechanisms, according to various embodiments of the present technology. FIG. 1 demonstrates an exemplary process according to the present technology. For example, time-sequenced events (e.g. time sequence 125) and corresponding multi-dimensional alert signatures 130, are sorted into cosine similarity buckets 160. The cosine similarity buckets 160 are represented by a vectorized bucket of numerical values (e.g., vectored buckets 170). The final stages involve using this vectorized data (e.g., vectored buckets 170) as input for training datasets (e.g., training data 185), with subsequent testing datasets (e.g., first test dataset 190 and second test dataset 195) utilized to validate the model's accuracy. The first test dataset 190 exemplifies clarity and predictability that is labeled “easy to figure out” as shown in FIG. 1. In contrast, the second test dataset 195 illustrates a more complex scenario that the model must decipher as is labeled “hard to figure out”. The exemplary block diagram 100 shown in FIG. 1 exemplifies the capability of the present technology to intelligently predict security events, thus enhancing preemptive cyber defense mechanisms.

According to various embodiments, time-sequenced events (e.g. time sequence 125) comprise sequence 101, sequence 102, sequence 103, sequence 103, sequence 104, sequence 105, sequence 106, sequence 107, sequence 108, sequence 109, sequence 110, and so forth. According to various embodiments, the time-sequenced events from sequence 101 through sequence 110, respectively correspond to various alerts such as port scan alert 111 form tool vender A, port scan alert 112 form tool vender B, brute force login alert 113 form tool vender C, brute force login alert 114 form tool vender D, brute force login alert 115 form tool vender E, abnormal login alert 116 form tool vender F, abnormal login alert 117 form tool vender G, abnormal data transfer alert 118 form tool vender H, data deletion alert 119 form tool vender I, cover up tracks alert 120 form tool vender J. Each of the various alerts comprise a multi-dimensional alert signature (e.g., multi-dimensional alert signature 131 through multi-dimensional alert signature 140).

According to various embodiments, the multi-dimensional alert signatures (e.g., multi-dimensional alert signature 131 through multi-dimensional alert signature 140), are sorted into cosine similarity buckets 160. The cosine similarity buckets 160 comprise port scan alerts 161 (corresponding to port scan alert 111 form tool vender A and port scan alert 112 form tool vender B), brute force login alerts 162 (corresponding to brute force login alert 113 form tool vender C, and brute force login alert 114 form tool vender D, brute force login alert 115 form tool vender E), abnormal login alerts 163 (corresponding to abnormal login alert 116 form tool vender F and abnormal login alert 117 form tool vender G), abnormal data transfer alert 164 (corresponding to abnormal data transfer alert 118 form tool vender H), data deletion alert 165 (corresponding to data deletion alert 119 form tool vender I), and cover up tracks alert 166 (corresponding to cover up tracks alert 120 form tool vender J).

According to various embodiments, the cosine similarity buckets 160 are represented by a vectorized bucket of numerical values (e.g., vectored buckets 170). In other words, the vectored buckets 170 are representations of numerical values. For example, the port scan alerts 161 correspond to vectorized bucket 171 (corresponding to port scan alert 111 form tool vender A and port scan alert 112 form tool vender B), the brute force login alerts 162 correspond to vectorized bucket 172 (corresponding to brute force login alert 113 form tool vender C, and brute force login alert 114 form tool vender D, and brute force login alert 115 form tool vender E), abnormal login alerts 163 correspond to vectorized bucket 173 (corresponding to abnormal login alert 116 form tool vender F and abnormal login alert 117 form tool vender G), abnormal data transfer alert 164 corresponds to vectorized bucket 174 (corresponding to abnormal data transfer alert 118 form tool vender H), data deletion alert 165 corresponds to vectorized bucket 175 (corresponding to data deletion alert 119 form tool vender I), and cover up tracks alert 166 corresponds to vectorized bucket 176 (corresponding to cover up tracks alert 120 form tool vender J).

According to various embodiments, the final stages involve using this vectorized data (e.g., vectored buckets 170) as input for training datasets (e.g., training data 185), with subsequent testing datasets utilized to validate the model's accuracy. The first test dataset 190 exemplifies clarity and predictability that is labeled “easy to figure out” as shown in FIG. 1. In contrast, the second test dataset 195 illustrates a more complex scenario that the model must decipher as is labeled “hard to figure out”. The exemplary block diagram 100 shown in FIG. 1 exemplifies the capability of the present technology to intelligently predict security events, thus enhancing preemptive cyber defense mechanisms.

Overall, FIG. 1 illustrates the block diagram 100 of a method for predicting security events, as enabled by the present technology according to some embodiments. The block diagram 100 begins with a series of time-sequenced events (e.g. time sequence 125), such as sequence 101 through sequence 110, each sequence is associated with multi-dimensional alert signatures 130. The multi-dimensional alert signatures 130 (multi-dimensional alert signature 131 through multi-dimensional alert signature 140) are sorted into cosine similarity buckets 160, the cosine similarity buckets 160 categorize the multi-dimensional alert signatures 130 (e.g., multi-dimensional alert signature 131 through multi-dimensional alert signature 140) into distinct types such as port scan alerts 161, brute force login alerts 162, abnormal login alerts 163, abnormal data transfer alerts 164, data deletion alerts 165, and cover up tracks alerts 166. Each bucket of the cosine similarity buckets 160 is then represented by a vectorized bucket of numerical values (e.g., vectored buckets 170), facilitating the transformation of qualitative alert data into a quantitative format suitable for machine learning analysis. The vectorized data (e.g., vectored buckets 170) is subsequently used to train datasets, as shown in the training data section, and is validated by test datasets. For example, the first test dataset 190 is labeled as “easy to figure out,” indicating a straightforward scenario for the predictive model, while the second test dataset 195 is labeled as “hard to figure out,” representing a more complex scenario that challenges the model's predictive capabilities. This structured approach exemplifies the ability of the present technology to intelligently predict security events, thereby enhancing preemptive cyber defense mechanisms.

According to various embodiments, within the scope of the predictive analytics capabilities of the present technology, embodiments employ the Long Short-Term Memory (LSTM) machine learning model, though the present technology is not restricted to employing the LSTM model. The LSTM model is a type of recurrent neural network (RNN) particularly adept at learning from sequences of data, making the LSTM model ideal for time-series analysis such as that required for predicting cyber security events in some embodiments. Unlike standard feedforward neural networks, LSTM includes feedback connections that allow the LSTM model to process not just single data points, but entire sequences of data. This architecture enables the LSTM to retain information over longer periods, which is instrumental in recognizing patterns in complex and time-dependent datasets.

According to some embodiments, the LSTM model's output, in the context of the present technology, is a predictive indication of the next likely event or events to occur, categorized into the predefined buckets. Accompanying each prediction is a probability score, reflecting the LSTM model's confidence in the prediction's accuracy. When the system generates multiple potential outcomes, these are ranked in descending order of their probability scores, thus prioritizing predictions based on their likelihood. This ranking provides an intuitive and actionable forecast, empowering security analysts to focus on the most probable threats as identified by the robust analysis of the LSTM model.

In some embodiments, the detailed LSTM model application to operation of the present provides a reliable method for anticipating cyber threats with high accuracy and facilitating proactive security measures.

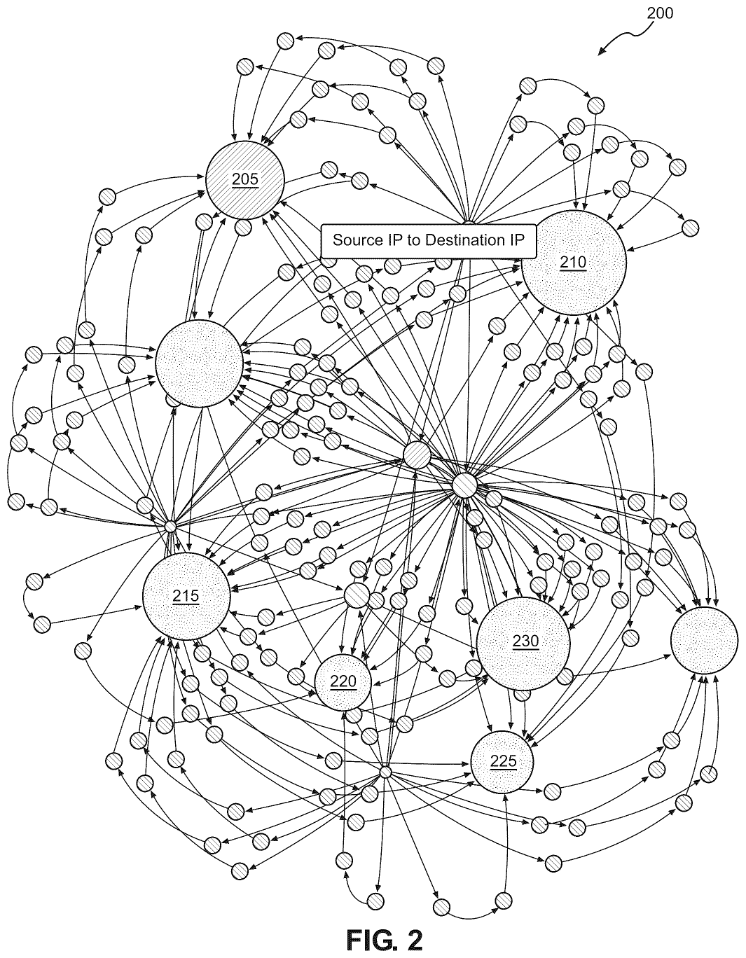

FIG. 2 shows a diagram of an exemplary knowledge based graph 200 of an exemplary machine learning predicting cybersecurity events model for intelligently predicting cybersecurity events for preemptive cybersecurity defense mechanisms, according to exemplary embodiments of the present technology. The knowledge based graph 200 of FIG. 2 illustrates a network of nodes, for example, source Internet Protocol address (IP) address, destination IP address, type of machine (e.g., windows, MAC, and so forth) username, tool (e.g., Splunk), type of attack (e.g., brute force login attempt, spread of ransomware, malware download, and the like), event, and so forth. The knowledge based graph 200 illustrates the relationships between the nodes. For example, the larger circles (nodes) represent more connections and the smaller circles (nodes) represent fewer connections. Exemplary nodes include malware download node 205, brute force login attempt node 210, SQL injection attempt node 215, successful login after brute force login node 220, ransomware spread node 225, and port scan node 230.

According to some embodiments, the source IP address and destination IP address are components of the knowledge based graph 200 used for predicting security events. The source IP address and destination IP address serve as nodes within the graph, representing the origin and target of network communications, respectively. The relationships between nodes including the source IP address and destination IP address and other elements, such as the type of machine, username, and type of attack, are analyzed to identify patterns and correlations that may indicate potential security threats. By examining the interactions between source IP address and destination IP address with other elements, the system can detect unusual or suspicious activity, such as unauthorized access attempts or data exfiltration, which may be crucial for preemptive cyber defense mechanisms. The analysis of source IP address and destination IP address, in conjunction with other data points, enhances the system's ability to predict and respond to cyber threats with greater accuracy and efficiency.

FIG. 2 presents the knowledge based graph 200 that illustrates the network of relationships between various nodes involved in predicting security events for preemptive cyber defense mechanisms. The nodes in the graph represent key elements such as source IP addresses, destination IP addresses, types of machines (e.g., Windows, Mac), usernames, tools (e.g., Splunk), and types of attacks (e.g., brute force login attempts, ransomware spread, malware downloads). The graph visually depicts the connections and interactions between these nodes, with larger circles indicating nodes with more connections and smaller circles representing nodes with fewer connections. This graphical representation helps in understanding the complex interdependencies and correlations among different network components, enabling the system to identify patterns that may signify potential security threats. By analyzing these relationships, the system can detect unusual or suspicious activities, thereby enhancing its ability to predict and respond to cyber threats with greater accuracy and efficiency.

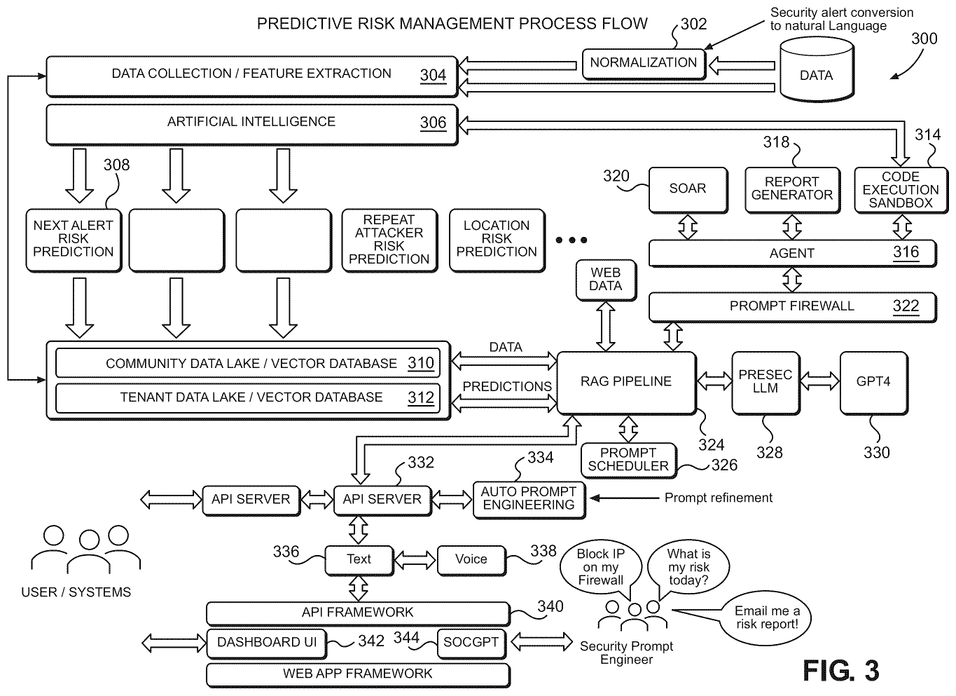

FIG. 3 shows a block diagram 300 of an exemplary system architecture used for a intelligently predicting cybersecurity events for preemptive cybersecurity defense mechanisms, according to various embodiments of the present technology. The block diagram 300 outlines the integration of various components and processes involved in predicting and managing cybersecurity risks. For example, normalization 302 represents each the vectorized bucket of numerical values (e.g., vectored buckets 170) of FIG. 1, which facilitates the transformation of qualitative alert data into a quantitative format suitable for machine learning analysis. For example, after data collection/feature extraction 304, Artificial Intelligence (AI) 306 of the block diagram 300 shown in FIG. 3 enables next alert risk prediction 308 as disclosed herein. For example, the next alert risk prediction 308 supports multiple prediction types including repeat attacker risk prediction, location risk prediction, just to name a few. In various embodiments, the block diagram 300 and exemplary system architecture shown in FIG. 3 enables other functionalities including but not limited to: malware risk prediction, phishing risk prediction, ransomware risk prediction, recurrence risk prediction, user risk prediction, network risk prediction, server risk prediction, data theft prediction, domain risk prediction, Operation Technology (OT) risk prediction, repeat attacker risk prediction, and location risk prediction, just to name a few examples, according to various embodiments. Data is stored in community data lake 310 and tenant data lake 312, which serve as vector databases for analysis. The Artificial Intelligence (AI) 306 may use a code execution sandbox that communicates with an agent 316. The agent 316 may use a report generator 318 and a SOAR (security orchestration, automation, and response) platform 320 of the present technology that comprises a stack of compatible software programs that enables collection and processing of data about cybersecurity threats and responding to security events automatically. The agent 316 may use a prompt firewall 322 that is connected to a Retrieval-Augmented Generation (RAG) pipeline 324. In the context of the predictive risk management process flow depicted by leveraging the strengths of both retrieval and generation, allowing the system to produce more accurate and contextually relevant outputs, the RAG pipeline 324 enhances the system's ability to predict and respond to cybersecurity threats. By retrieving pertinent data and using the pertinent data to inform predictive models, the RAG pipeline 324 helps improve the accuracy and reliability of risk assessments and threat predictions, thereby supporting more effective preemptive cyber defense mechanisms. The RAG pipeline 324 may use a prompt scheduler 326. In the predictive risk management process, the prompt scheduler 326 may work in conjunction with other components, such as the RAG pipeline 324 and Artificial Intelligence (AI) 306 (i.w., artificial intelligence module), to optimize the flow of information and actions. By effectively scheduling prompts, the system can maintain a continuous and dynamic assessment of cybersecurity threats, allowing for timely predictions and responses. This capability enhances the system's overall efficiency and effectiveness in preemptively managing risks and mitigating potential security breaches. The RAG pipeline 324 is also connected to AI models such as a secure LLM 328 and GPT-4 330. By leveraging GPT-4, the system can translate complex log data into a more interpretable format, facilitating the categorization and analysis of security events. This transformation enables the system to generate predictive insights and enhance its ability to anticipate and respond to cybersecurity threats. For example, advanced capabilities of GPT-4 in language processing make GPT-4 a valuable tool for improving the accuracy and efficiency of predictive risk management and cyber defense mechanisms.

In some embodiments, the RAG pipeline 324 is also connected to API server 332 and auto prompt engineering 334. Auto prompt engineering 334 involves automatically generating and adjusting prompts to ensure that the system effectively interprets and processes data, leading to more accurate predictions and responses to cybersecurity threats. By automating prompt engineering, the system can dynamically adapt to changing data patterns and threat landscapes, improving its ability to manage risks proactively. This capability not only streamlines the system's operations but also enhances its overall efficiency and effectiveness in maintaining robust cybersecurity defenses.

According to various embodiments, API server 332 receives both text input 336 and voice input 338 using an API framework 340. The API framework 340 uses SOCGPT 344, which is a specialized implementation of a language model (e.g., GPT-4) that is tailored for use in a Security Operations Center (SOC). SOCGPT 344 is designed to assist cybersecurity professionals by providing advanced natural language processing capabilities to analyze, interpret, and respond to security-related data. For example, SOCGPT 344 may be used to automate the interpretation of complex security logs, generate insights from vast amounts of data, and assist in decision-making processes by providing contextually relevant information. SOCGPT 344 facilitates communication within the SOC by generating reports, summarizing incidents, and suggesting potential responses to detected threats. For example, a security prompt engineer may have the following voice inputs such as: “Block IP on my firewall”, “What are my risks today?”, and “Email me a risk report”. By leveraging the capabilities of SOCGPT 344, the system can enhance the efficiency and effectiveness of cybersecurity operations, enabling faster and more accurate threat detection and response. The API framework 340 may use a dashboard User Interface (UI) 342 to communicate with users.

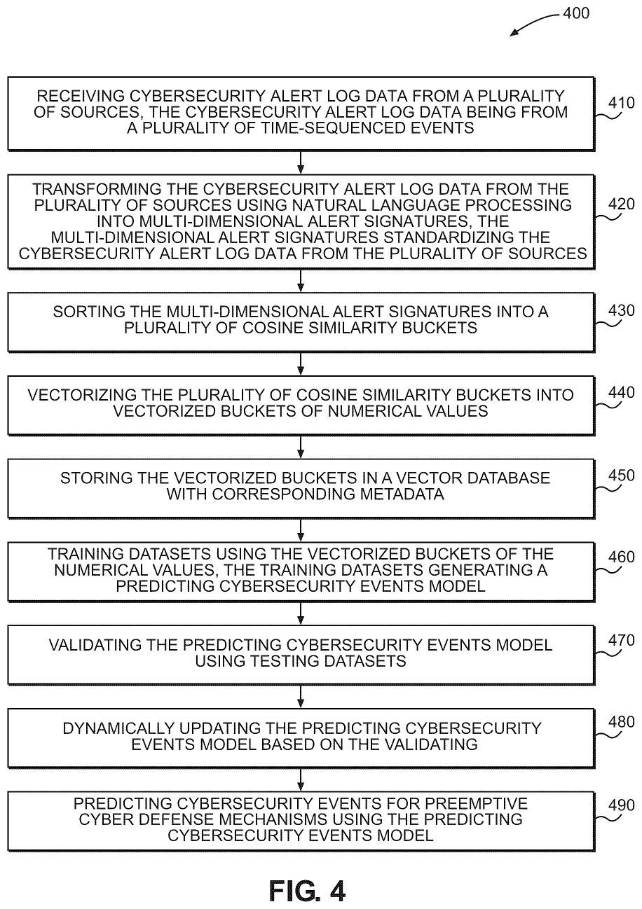

FIG. 4 is a block diagram of a process flow for intelligently predicting cybersecurity events for preemptive cybersecurity defense mechanisms, according to various embodiments of the present technology. FIG. 4 is a flowchart of an example method for intelligently predicting cybersecurity events for preemptive cybersecurity defense mechanisms, comprising the following steps. At step 410, receiving cybersecurity alert log data from a plurality of sources, the cybersecurity alert log data being from a plurality of time-sequenced events. At step 420, transforming the cybersecurity alert log data from the plurality of sources using natural language processing into multi-dimensional alert signatures, the multi-dimensional alert signatures standardizing the cybersecurity alert log data from the plurality of sources. At step 430, sorting the multi-dimensional alert signatures into a plurality of cosine similarity buckets. At step 440, vectorizing the plurality of cosine similarity buckets into vectorized buckets of numerical values. At step 450, storing the vectorized buckets in a vector database with corresponding metadata. At step 460, training datasets using the vectorized buckets of the numerical values, the training datasets generating a predicting cybersecurity events model. At step 470, validating the predicting cybersecurity events model using testing datasets. At step 480, dynamically updating the predicting cybersecurity events model based on the validating. At step 490, predicting cybersecurity events for preemptive cyber defense mechanisms using the predicting cybersecurity events model.

According to some embodiments cybersecurity alert log data refers to the records generated by security systems and tools that document events or activities deemed significant for monitoring and analysis. These logs provide detailed information about potential security incidents, system performance, and user activities.

According to some embodiments plurality of sources refers to multiple distinct origins or points from which data is collected or received. In the context of receiving cybersecurity alert log data, plurality of sources indicates that the data is being gathered from various security tools or systems, such as firewalls, antivirus software, intrusion detection systems, and network monitoring tools. These sources provide diverse and potentially heterogeneous data, which is then aggregated and processed to form a comprehensive view of cybersecurity events. The use of multiple sources enhances the robustness and accuracy of the analysis by incorporating a wide range of data inputs.

According to some embodiments plurality of time-sequenced events refers to multiple events that are organized or recorded in chronological order based on the time they occurred. In the context of cybersecurity alert log data, this means that the data includes a series of events, each with a timestamp metadata, allowing for the analysis of the sequence and timing of these events. This chronological arrangement may be significant for understanding the progression of activities within a system, identifying patterns or anomalies, and predicting future events. By analyzing a plurality of time-sequenced events, the system can gain insights into the temporal dynamics of cybersecurity incidents, which may be essential for effective predicting of future events.

According to some embodiments, transforming the cybersecurity alert log data from the plurality of sources using natural language processing into multi-dimensional alert signatures includes a process in which raw log data from various security tools and systems is converted into a standardized and enriched format. For example, transforming may involve changing the format or structure of the data to make it more useful for analysis. For instance, converting raw log data into a more structured and interpretable form.

According to some embodiments Natural Language Processing (NLP) refers to a field of artificial intelligence that focuses on the interaction between computers and humans through natural language. The present technology uses NLP to interpret and standardize the log data, making it more accessible and easier to analyze

According to some embodiments multi-dimensional alert signatures refers to standardized representations of alert log data that capture multiple aspects of an event, allowing for consistent analysis and categorization across different data sources, enabling more effective threat detection and prediction.

According to some embodiments sorting the multi-dimensional alert signatures into a plurality of cosine similarity buckets refers to a method of organizing and categorizing alert data based on their similarity. For example, sorting involves arranging or classifying data into specific categories or groups based on defined criteria. For instance, organizing alert signatures into distinct buckets.

According to some embodiments cosine similarity uses a mathematical measure to determine the similarity between two vectors. For example, cosine similarity calculates the cosine of the angle between two vectors, providing a value between −1 and 1, where 1 indicates identical vectors, 0 indicates orthogonal vectors, and −1 indicates completely opposite vectors. For instance, by sorting multi-dimensional alert signatures into cosine similarity buckets, the system can effectively categorize and group similar security events, despite their disparate origins and descriptions. This categorization facilitates a more structured and uniform dataset for subsequent machine learning analysis, enhancing the prediction and detection capabilities of cybersecurity systems.

According to some embodiments vectorizing the plurality of cosine similarity buckets into vectorized buckets of numerical values describes a process of converting categorized alert data into a numerical format that can be processed by machine learning algorithms. According to some embodiments vectorization refers to the process of converting data into a numerical format that can be processed by machine learning algorithms. For example, vectorization involves transforming alert signatures into vectorized numerical values for analysis. For example, in some embodiments vectorized buckets of numerical values is converting cosine similarity buckets into numerical vectors and this transformation encapsulates the essence of the alert data in a mathematical array, making vectorized buckets the of numerical values suitable for machine learning analysis. For instance, by vectorizing the cosine similarity buckets, the system translates qualitative alert data into a quantitative format. This conversion may be significant for enabling advanced analytics and machine learning models to process and analyze the data efficiently, ultimately enhancing the system's ability to predict cybersecurity threats.

According to some embodiments training datasets using the vectorized buckets of numerical values, the training datasets generating a predicting cybersecurity events model describes a process in which machine learning models are developed to forecast future cybersecurity events. For example, training datasets uses collections of data used to teach a machine learning model how to recognize patterns and make predictions. For instance, the training datasets may include vectorized numerical values derived from the cosine similarity buckets. By training datasets with vectorized numerical values, the system leverages machine learning techniques to create a predictive model. This predicting cybersecurity events model can analyze past cybersecurity incidents and forecast future events, enhancing the system's ability to proactively manage and mitigate potential threats.

According to some embodiments predicting cybersecurity events model refers to a machine learning model trained to forecast potential future security incidents based on historical log data patterns.

According to some embodiments dynamically updating the predicting cybersecurity events model based on the validating refers to the process of continuously improving the accuracy and effectiveness of a machine learning model used for predicting cybersecurity events. For example, by dynamically updating the model, the present technology remains effective in predicting cybersecurity events as new data becomes available or as threat patterns evolve. This continuous improvement process helps maintain the predicting cybersecurity events model relevance and accuracy, allowing the predicting cybersecurity events model to adapt to changing cybersecurity landscapes and provide more reliable predictions.

According to some embodiments a vector database refers to a storage system designed to handle vectorized data, allowing for efficient retrieval and analysis of numerical representations of alert signatures.

According to some embodiments Long Short-Term Memory (LSTM) Neural Network refers to a type of recurrent neural network (RNN) particularly suited for learning from sequences of data. LSTMs are used in this context to analyze time-sequenced log data for predicting future cybersecurity events.

According to some embodiments code execution sandbox refers to secure, isolated environment used to execute and test code without affecting the host system. The code execution sandbox allows for safe analysis of potentially harmful code to understand its behavior.

According to some embodiments Security Orchestration, Automation, and Response (SOAR) Platform refers to a system that integrates security tools and processes to automate the response to security incidents, enhancing the efficiency and effectiveness of cybersecurity operations.

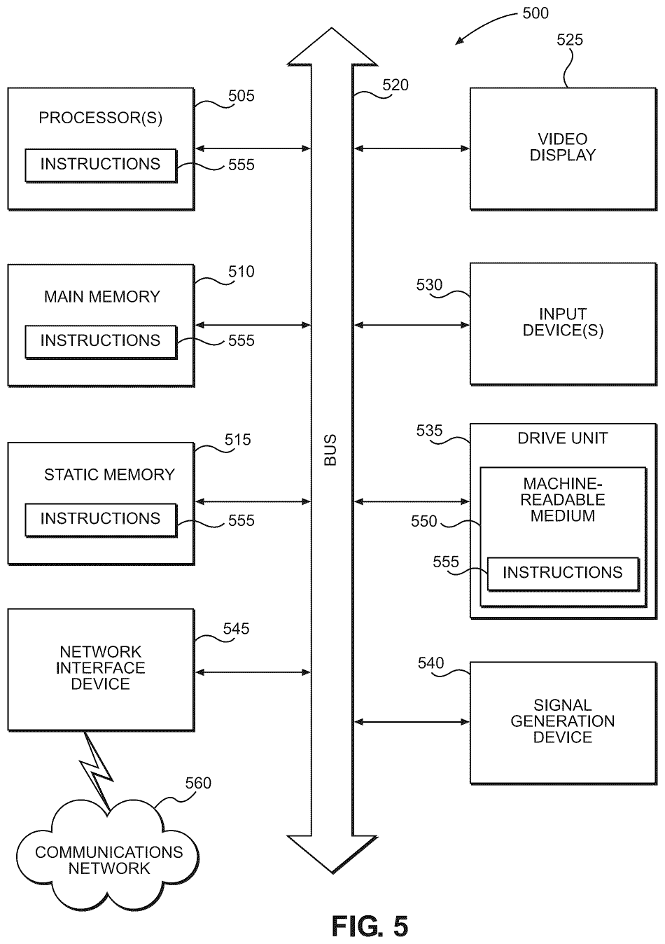

FIG. 5 shows a diagrammatic representation of a computing device for a machine in the example electronic form of a computer system 500, within which a set of instructions for causing the machine to perform any one or more of the methodologies discussed herein can be executed. In example embodiments, the machine operates as a standalone device, or can be connected (e.g., networked) to other machines. In a networked deployment, the machine can operate in the capacity of a server, a client machine in a server-client network environment, or as a peer machine in a peer-to-peer (or distributed) network environment. The machine can be a personal computer (PC), tablet PC, game console, set-top box (STB), personal digital assistant (PDA), television device, cellular telephone, portable music player (e.g., a portable hard drive audio device), web appliance, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methodologies discussed herein.

The example computer system 500 includes a processor or multiple processors 505 (e.g., a central processing unit (CPU), a graphics processing unit (GPU), or both), and a main memory 510 and a static memory 515, which communicate with each other via a bus 520. The computer system 500 can further include a video display unit 525 (e.g., a liquid-crystal display (LCD), organic light emitting diode (OLED) display, or a cathode ray tube (CRT)). The computer system 500 also includes at least one input device 530, such as an alphanumeric input device (e.g., a keyboard), a cursor control device (e.g., a mouse), a microphone, a digital camera, a video camera, and so forth. The computer system 500 also includes a disk drive unit 535, a signal generation device 540 (e.g., a speaker), and a network interface device 545.

The drive unit 535 (also referred to as the disk drive unit 535) includes a machine-readable medium 550 (also referred to as a computer-readable medium 550), which stores one or more sets of instructions and data structures (e.g., instructions 555) embodying or utilized by any one or more of the methodologies or functions described herein. The instructions 555 can also reside, completely or at least partially, within the main memory 510, static memory 515 and/or within the processor(s) 505 during execution thereof by the computer system 500. The main memory 510, static memory 515, and the processor(s) 505 also constitute machine-readable media.

The instructions 555 can further be transmitted or received over a communications network 560 via the network interface device 545 utilizing any one of a number of well-known transfer protocols (e.g., Hyper Text Transfer Protocol (HTTP), CAN, Serial, and Modbus). The communications network 560 includes the Internet, local intranet, Personal Area Network (PAN), Local Area Network (LAN), Wide Area Network (WAN), Metropolitan Area Network (MAN), virtual private network (VPN), storage area network (SAN), frame relay connection, Advanced Intelligent Network (AIN) connection, synchronous optical network (SONET) connection, digital T1, T3, E1 or E3 line, Digital Data Service (DDS) connection, Digital Subscriber Line (DSL) connection, Ethernet connection, Integrated Services Digital Network (ISDN) line, cable modem, Asynchronous Transfer Mode (ATM) connection, or an Fiber Distributed Data Interface (FDDI) or Copper Distributed Data Interface (CDDI) connection. Furthermore, communications network 560 can also include links to any of a variety of wireless networks including Wireless Application Protocol (WAP), General Packet Radio Service (GPRS), Global System for Mobile Communication (GSM), Code Division Multiple Access (CDMA) or Time Division Multiple Access (TDMA), cellular phone networks, Global Positioning System (GPS), cellular digital packet data (CDPD), Research in Motion, Limited (RIM) duplex paging network, Bluetooth radio, or an IEEE 802.11-based radio frequency network.

While the machine-readable medium 550 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, XML, Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, C #, .NET, Adobe Flash, Perl, UNIX Shell, Visual Basic or Visual Basic Script, Virtual Reality Markup Language (VRML), ColdFusion™ or other compilers, assemblers, interpreters, or other computer languages or platforms.

Thus, the technology of intelligently predicting security events for preemptive cyber defense mechanisms is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer implemented method of intelligently predicting cybersecurity events for preemptive cybersecurity defense mechanisms, comprising:
receiving cybersecurity alert log data from a plurality of sources, the cybersecurity alert log data being from a plurality of time-sequenced events;
transforming the cybersecurity alert log data from the plurality of sources using natural language processing into multi-dimensional alert signatures, the multi-dimensional alert signatures standardizing the cybersecurity alert log data from the plurality of sources;
sorting the multi-dimensional alert signatures into a plurality of cosine similarity buckets;
vectorizing the plurality of cosine similarity buckets into vectorized buckets of numerical values;
storing the vectorized buckets in a vector database with corresponding metadata;
training datasets using the vectorized buckets of the numerical values, the training datasets generating a predicting cybersecurity events model;
validating the predicting cybersecurity events model using testing datasets;
dynamically updating the predicting cybersecurity events model based on the validating; and
predicting cybersecurity events for preemptive cyber defense mechanisms using the predicting cybersecurity events model.

2. The method of claim 1, wherein the transforming the cybersecurity alert log data from the plurality of sources applies a predefined template for generating the multi-dimensional alert signatures.

3. The method of claim 1, wherein the predicting cybersecurity events for preemptive cyber defense executes a cosine similarity analysis on the vectorized buckets of numerical values with the corresponding metadata.

4. The method of claim 3, wherein the cosine similarity analysis generates a plurality of cybersecurity alert log categories.

5. The method of claim 4, further comprising categorizing the plurality of cybersecurity alert log categories, using a machine learning engine, into predefined cybersecurity threat categories.

6. The method of claim 5, wherein the metadata comprises:
cybersecurity alert log data metadata, the cybersecurity alert log data metadata being from the cybersecurity alert log data from the plurality of sources, and
multi-dimensional alert signatures metadata, the multi-dimensional alert signatures metadata being from the multi-dimensional alert signatures.

7. The method of claim 6, wherein the cybersecurity alert log data metadata comprises event timestamps of the time-sequenced events.

8. The method of claim 7, further comprising temporal sequencing the plurality of cybersecurity alert log categories using the event timestamps of the time-sequenced events, the temporal sequencing the plurality of cybersecurity alert log categories generating a historical pattern of cyber cybersecurity incidents for the predicting cybersecurity events model.

9. The method of claim 1, further comprising arranging the vectorized buckets of numerical values into a temporal sequence based on timestamp metadata to establish a chronological pattern of cybersecurity events.

10. The method of claim 1, wherein the predicting cybersecurity events model comprises a Long Short-Term Memory (LSTM) neural network configured to analyze time-sequenced data for predicting future cybersecurity events.

11. The method of claim 1, wherein the predicting cybersecurity events for preemptive cyber defense mechanisms using the predicting cybersecurity events model generates a probability score for each predicted cybersecurity event.

12. The method of claim 11, further comprising ranking predicted cybersecurity events using the probability score for each predicted cybersecurity event, the ranking prioritizing the predicted cybersecurity events based on a likelihood of occurrence of each of the predicted cybersecurity events.

13. The method of claim 12, wherein the predicting cybersecurity events for preemptive cyber defense mechanisms using the predicting cybersecurity events model comprises generating a cybersecurity report for an entity, the cybersecurity report for the entity being based on the ranking the predicted cybersecurity events.

14. The method of claim 1, wherein the validating the predicting cybersecurity events model using testing datasets executes the predicting cybersecurity events model using a code execution sandbox, the code execution sandbox testing the predicting cybersecurity events model.

15. The method of claim 1, further comprising automatically responding to a predicted cybersecurity event using a security orchestration, automation and response platform, the predicted cybersecurity event being based on the predicting cybersecurity events for preemptive cyber defense mechanisms using the predicting cybersecurity events model.

16. A system for intelligently predicting cybersecurity events for preemptive cybersecurity defense mechanisms, comprising:
at least one processor; and
a memory storing processor-executable instructions, wherein the at least one processor is configured to implement the following operations upon executing the processor-executable instructions:
receiving cybersecurity alert log data from a plurality of sources, the cybersecurity alert log data being from a plurality of time-sequenced events;
transforming the cybersecurity alert log data from the plurality of sources using natural language processing into multi-dimensional alert signatures, the multi- dimensional alert signatures standardizing the cybersecurity alert log data from the plurality of sources;
sorting the multi-dimensional alert signatures into a plurality of cosine similarity buckets;
vectorizing the plurality of cosine similarity buckets into vectorized buckets of numerical values;
storing the vectorized buckets in a vector database with corresponding metadata;
training datasets using the vectorized buckets of the numerical values, the training datasets generating a predicting cybersecurity events model;
validating the predicting cybersecurity events model using testing datasets;
dynamically updating the predicting cybersecurity events model based on the validating; and
predicting cybersecurity events for preemptive cyber defense mechanisms using the predicting cybersecurity events model.

17. The system of claim 16, wherein the predicting cybersecurity events for preemptive cyber defense executes a cosine similarity analysis on the vectorized buckets of numerical values with the corresponding metadata.

18. The system of claim 17, wherein the cosine similarity analysis generates a plurality of cybersecurity alert log categories.

19. The system of claim 18,, further comprising categorizing the plurality of cybersecurity alert log categories, using a machine learning engine, into predefined cybersecurity threat categories.

20. A non-transitory computer-readable storage medium having embodied thereon instructions, which when executed by at least one processor, perform operations of a method comprising:
receiving cybersecurity alert log data from a plurality of sources, the cybersecurity alert log data being from a plurality of time-sequenced events;
transforming the cybersecurity alert log data from the plurality of sources using natural language processing into multi-dimensional alert signatures, the multi-dimensional alert signatures standardizing the cybersecurity alert log data from the plurality of sources;
sorting the multi-dimensional alert signatures into a plurality of cosine similarity buckets;
vectorizing the plurality of cosine similarity buckets into vectorized buckets of numerical values;
storing the vectorized buckets in a vector database with corresponding metadata;
training datasets using the vectorized buckets of the numerical values, the training datasets generating a predicting cybersecurity events model;
validating the predicting cybersecurity events model using testing datasets;
dynamically updating the predicting cybersecurity events model based on the validating; and
predicting cybersecurity events for preemptive cyber defense mechanisms using the predicting cybersecurity events model.
